(19) United States
(12) Patent Application Publication
(10) Pub. No.: US 2013/0212529 A1
(43) Pub. Date: Aug. 15, 2013

(54) USER INTERFACE FOR TOUCH AND SWIPE NAVIGATION

(71) Applicant: Samsung Electronics Co., Ltd., (US)

(72) Inventor: Somalapuram AMARNATH, Bangalore (IN)

(73) Assignee: Samsung Electronics Co., Ltd., Gyeonggi-do (KR)

(21) Appl. No.: 13/766,274

(22) Filed: Feb. 13, 2013

(30) Foreign Application Priority Data
Feb. 13, 2012 (IN) 533/CHE/2012

(51) Int. Cl. G06F 3/01; G06F 3/0482

(52) U.S. Cl. CPC G06F 3/017; G06F 3/0482
USPC 715/810

(57) ABSTRACT

A method and device to create a user interface for touch and swipe navigation in a touch sensitive mobile device is provided. A touch action performed by a user is identified on the touch screen display, a context related to the touch action is identified, a menu is displayed based on the identified context, and a menu option corresponding to direction of swipe performed onto the menu is selected from among options of the menu, without removing the touch.

### PRIORITY

This application claims priority under 35 U.S.C. § 119(a) to an Indian Patent Application filed in the Indian Patent Office on Feb. 13, 2012 and assigned Serial No. 533/CHE/2012, the contents of which are incorporated herein by reference.

### BACKGROUND OF THE INVENTION

1. Field of the Invention

The present invention generally relates to graphical user interface, and more particularly to a user interface for touch and swipe user input in a mobile device.

2. Description of the Related Art

With the evolution of mobile communication technology there has been a tremendous increase in the number of functionalities offered on the mobile device. Further, the increases in the functionalities offer a challenge to design interfaces on such mobile devices. The challenge is particularly significant on portable hand held devices such as mobile phones, smart phones, tablets, etc. In these mobile devices, as the number of functionalities increase, accommodating functional keys or buttons becomes a difficulty. Further, the display or the user interface acts as a very important component of the device. This is because the interface acts as a gateway through which the user is able to interact with the device. The user employs the interface in order to send or receive messages or access any means of communication, and also to visit applications of interest. Due to all these reasons, the design of the graphical user interface becomes very important in mobile devices.

In present day mobile devices, the increase in the functionalities has resulted in the addition of the number of buttons. As the applications and functions provided by the device increases, there is an increase in the density of the push buttons, overloading the functions of the push buttons to accommodate the functions and applications. Due to this, the user menu becomes very complex to store, access and manipulate data. As a result, present day interfaces typically comprise complex key interfaces, sequences, and menu hierarchies that must be memorized by the user. In addition, the physical push buttons are inflexible. This, together with the complexity involved in the display due to the functionalities, is frustrating to users. Hence, user experience will not be a pleasure.

Some methods offer touch sensitive user interfaces in order to overcome the problem of density of the buttons. These methods allow the user to interact with the device by a touch. In addition, some of them also allow a swipe feature wherein the user is able to access an icon or button of his choice by just swiping his finger on it. This may reduce the complexity involved; however, there are some serious drawbacks associated with them, which include the touch sensitive or swipe feature moving a service control object from one position to another position on the screen a specific distance. Further, there is a defined area where the touch or swipe is active, and hence the user needs to perform the required action in this particular area only. In this case, when the user swipes out of the area there is no action taking place. Further, when there are numerous applications on the screen it becomes difficult for the user to touch/swipe in the small area available for each application as there is always a possibility of a wrong touch/swipe action, and hence a wrong application may get activated. In addition, as the number of applications increases the icons on the menu increase and most of the time a large percentage of these may not be used by the user at all. Due to this, the screen space is wasted. Numerous icons and applications may seem very confusing to the user and he may find it annoying.

Further, most of the interfaces do not offer a single touch or swipe feature. Due to this, the user will have to perform the touch/swipe multiple times until he gets access to his desired content. This process may be time consuming and user may not prefer it as it may require some manual effort on the user end. Also, there are no mechanisms to customize the menu and buttons as per user's choice.

Due to the aforementioned reasons, it is evident that existing touch sensitive mechanisms employed in mobile devices are not very effective. Further, they involve a large number of menus or drop down icons that are not favorable. As a result, a method that customizes the appearance of the menu or icons based on the user's interest is required. Also, the method must be user friendly to provide access to the required content with a touch or swipe.

### SUMMARY OF THE INVENTION

The present invention has been made to address the problems and disadvantages described above, and to provide at least the advantages described below. Accordingly, an aspect of the present invention is to provide a method and device for eliminating the complexities involved in a user interface.

Another aspect of the present invention is to provide a method and mobile device for rapidly and simply allowing multiple functions in single touch and swipe.

According to an aspect of the present invention, a method for providing a user interface for touch and swipe navigation on a mobile device having a touch screen display is provided. The method includes identifying a touch action performed by a user on the touch screen display; identifying a context related to the touch action; displaying a menu based on the identified context; and selecting a menu option corresponding to a direction of a swipe performed on the menu from among options of the menu, without removing the touch.

According to an aspect of the present invention, a mobile device for providing a user interface for touch and swipe navigation is provided. The mobile device includes a touch screen display; and a controller for identifying a touch action performed by a user on the touch screen display, identifying a context related to said the touch action, displaying a menu based on the identified context, and selecting a menu option corresponding to a direction of a swipe performed on the menu from among options of the menu, without removing the touch.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram of a mobile device according to an embodiment of the present invention;

FIG. 2 is a flow chart of a user interface for touch and swipe navigation according to an embodiment of the present invention;

FIG. 3 is a flow chart illustrating an example in which a wallpaper menu is selected by the user according to an embodiment of the present invention;

FIG. 4 illustrates a user interface containing different options according to an embodiment of the present invention;

FIGS. 5A through 5F illustrate examples of menu forms according to an embodiment of the present invention;

FIG. 6 illustrates examples of other menu forms according to an embodiment of the present invention;

FIG. 7 illustrates an example of other menu forms according to an embodiment of the present invention;

FIGS. 8A through 8C are examples of a menu display for touch and swipe navigation according to an embodiment of the present invention;

FIG. 9 illustrates a swipe out action according to an embodiment of the present invention;

FIG. 10 illustrates a sub menu according to an embodiment of the present invention;

FIG. 11 illustrates a menu with scroll speed control options for menu options according to an embodiment of the present invention;

FIGS. 12A through 12D illustrate a menu and a sub menu options according to an embodiment of the present invention; and

FIGS. 13A through 13H illustrate a message screen according to an embodiment of the present invention.

### DETAILED DESCRIPTION OF EMBODIMENTS OF THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein. In the drawings, similar reference characters denote corresponding features consistently throughout the figures.

A method and device to create a user interface for touch and swipe navigation in a touch sensitive mobile device are disclosed. The method and device enable the user of the mobile device to access a menu by touch and swipe functionality. This enables the user to access any menu with just a touch and swipe.

In an embodiment herein the mobile device referred to throughout the application may be a mobile phone, smart phone, PDA (Personal Digital Assistant), tablet, etc.

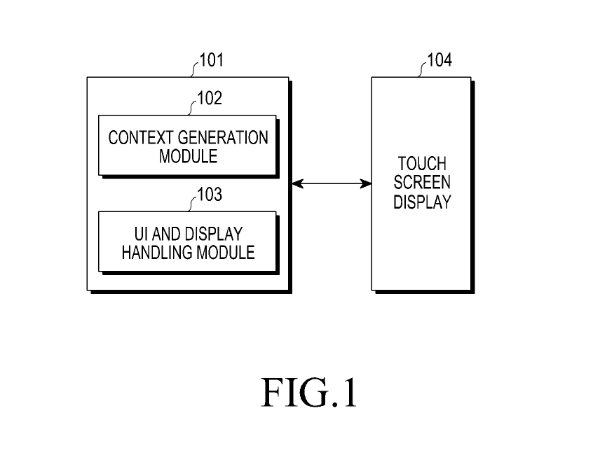

FIG. 1 is a block diagram of the mobile device according to an embodiment of the present invention. As depicted in FIG. 1, the mobile device comprises a controller 101 and a touch screen display 104, and the controller 101 comprises two modules such as context generation module 102 and UI (User Interface) and display handling module 103.

The context generation module 102 identifies the user touch and swipe action on the touch screen display 104, and based on that, the module performs the actions. In one embodiment, the user selects (by touch and swipe) a messaging option in the menu, and then context generation module 102 provides sub menus such as an inbox, outbox, sent items, and so on. The context generation module 102 handles all the actions performed by the user in the mobile device and processes those actions. The context generation module 102 is responsible for identifying the relevant context of the user's selection, a direction of a swipe or action, an angle of the action, etc. The context generation module 102 identifies the direction of the swipe on the screen of the touch screen display 104; it also determines the context of the user swipe and provides the context menu. The direction comprises the angle of swipe and location of swipe on the screen.

The UI and display handling module 103 provides the user interface in the display screen of the mobile device and display menus or sub-menus if the user performs a touch action. In one embodiment, the user initially performs a touch action on the screen and the UI and display handling module 103 displays the menus on the screen so that user can select any options in the displayed menu.

In an embodiment, the controller 101 may comprise an integrated circuit comprising at least one processor and one memory having a computer program code. The memory and the computer program code may be configured to, with the processor, to cause the apparatus to perform the required implementation.

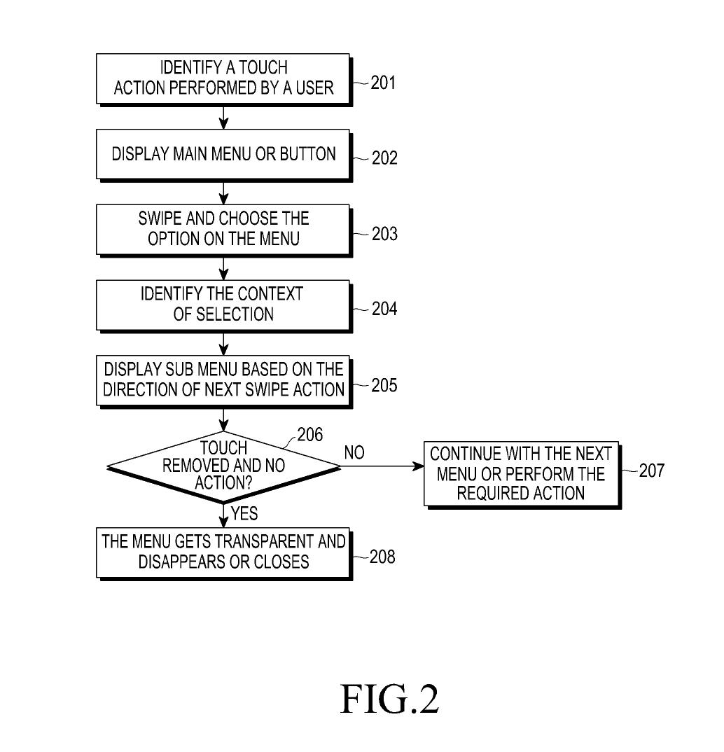

FIG. 2 is a flow chart of a user interface for touch and swipe navigation according to an embodiment of the present invention. A process according to the flow chart shown in FIG. 2 is performed by the controller 101 shown in FIG. 1. A user first performs a touch action on the screen of his mobile device, which may be a single touch, swipe, etc. The controller 101 identifies the touch performed by the user at step 201 and displays the menu or buttons on the display screen at step 202. When the user desires to look at different options in the menu, any of the options of the menu selected by the user is chosen by a swipe without removing the touch at step 203. The phrase “swipe without removing touch” means swiping while maintaining a touch state without performing a touch up after touch down. In one embodiment, the swipe direction may be determined based on several inputs, such as the initial point of contact/touch, the final point of contact/touch, the location of swipe, and angle of the swipe. All these help in determining the context of interest to the user.

The controller 101 then identifies the context in the option that the user swiped in the menu at step 204. The controller 101 identifies the context by determining the initial and final point of touch and direction of the touch action and linking the choice made by the user. The user then performs a next swipe action without removing the touch in the chosen option and the controller 101 identifies the direction of swipe to display a sub-menu under the selected option by the user at step 205. In one embodiment, if the user selects a gallery option in the displayed menu, then the controller 101 displays the images, videos, audio/music files as a sub-menu to the user. The controller 101 then checks whether the user again performs any touch action at step 206. If the controller 101 identifies a touch action by the user then the controller 101 performs the required action; otherwise, it displays the next menu at step 207.

In one embodiment, the user selects the images in the sub-menu of the camera option, and then the controller 101 displays the list of image folders in the gallery. The list of image folders includes a camera image folder, a downloaded image folder, a received image folder, etc. If the user selects the camera image folder then the controller 101 displays the images in the camera image folder.

In step 206, if the controller 101 identifies that no touch action is performed by the user, then the controller 101 changes the menu screen to be transparent, and the menu disappears or closes at step 208. The disappearing or closing action is performed by the controller 101 if a predetermined inactivity period has lapsed. In one embodiment, closing the menu is performed by making the menu transparent (dim) until the menu disappears. The predetermined inactivity period may be determined by the controller 101 and may be configured at the time of UI (User Interface) design. If the controller 101 does not receive a touch or swipe action from the user for a predetermined time, then the menu screen will be transparent and the menu disappears. The various actions shown in FIG. 2 may be performed in the order presented, in a different order or simultaneously. Further, in some embodiments, some actions listed in FIG. 2 may be omitted. A more detailed description of the foregoing menu and sub menu display and option choice will be described below.

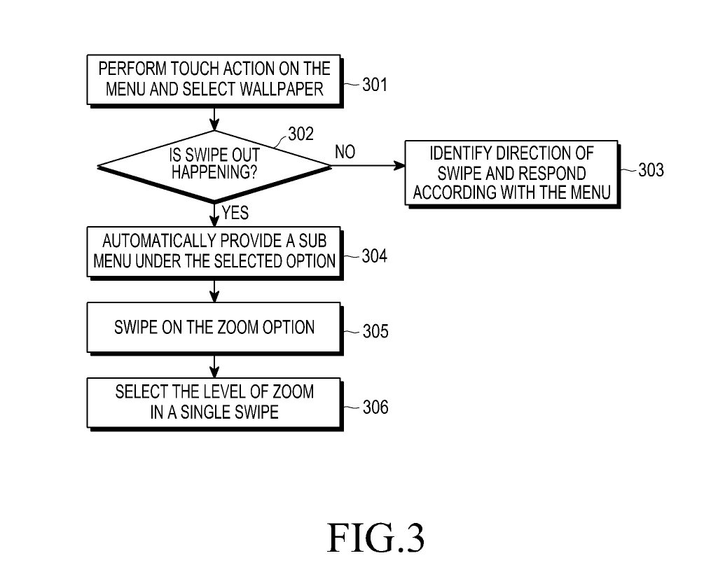

FIG. 3 is a flow chart illustrating an example in which a wallpaper menu is selected by the user according to an embodiment of the present invention. A process according to the flow chart shown in FIG. 3 is performed by the controller 101 shown in FIG. 1. A touch action is performed on the screen by the user and the wallpaper option is selected in the displayed menu at step 301. The controller 101 checks for any swipe out in the swipe action performed by the user at step 302. A “swipe out” is an action performed by the user in which the user swipes beyond the menu boundary. In one embodiment, if the controller 101 identifies there is no swipe out action in the wallpaper option by the user, then it responds to the user with a display appropriate to the swipe action performed by the user at step 303. In another embodiment, if the controller 101 identifies a swipe out action by the user, the controller 101 automatically provides the sub menu within the selected swipe out option at step 304. The controller 101 identifies a swipe out action in the wallpaper option and in response to this, the controller 101 displays the sub menu to the user. The sub menu may be a zoom, a move, and so on. The user swipes on the zoom option in the sub menu at step 305. The user then selects the level of zoom displayed which includes a zoom-in or zoom-out action at step 306. The various actions shown in FIG. 3 may be performed in the order presented, in a different order or simultaneously. Further, in some embodiments, some actions listed in FIG. 3 may be omitted.

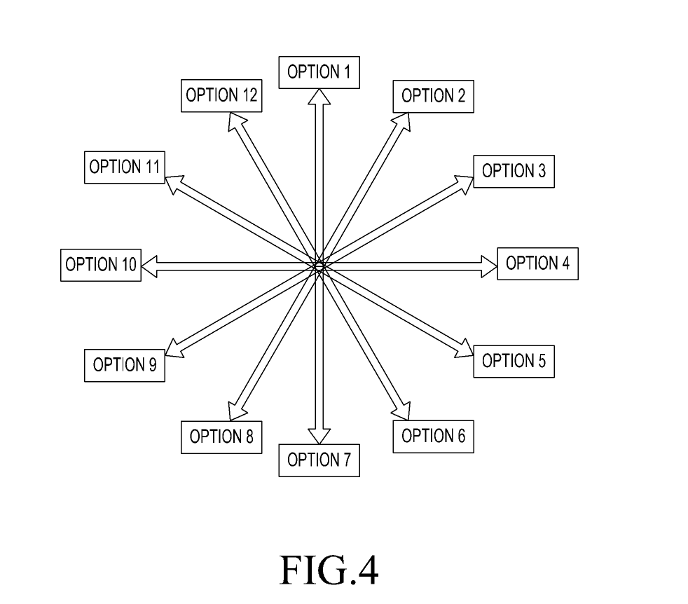

FIG. 4 illustrates the user interface that contains different options according to an embodiment of the present invention. The user may select the options to be displayed in the menu interface. As illustrated in FIG. 4, which has a plurality of options displayed in the menu interface, the user selects any of the plurality of the options displayed by a touch, or with a swipe without removing the touch. Once the user selects the option with a swipe then the mobile device displays a sub-menu or performs any other action in response to the user action. Further, the action may be performed in any direction on the screen of the mobile device as depicted in FIG. 4.

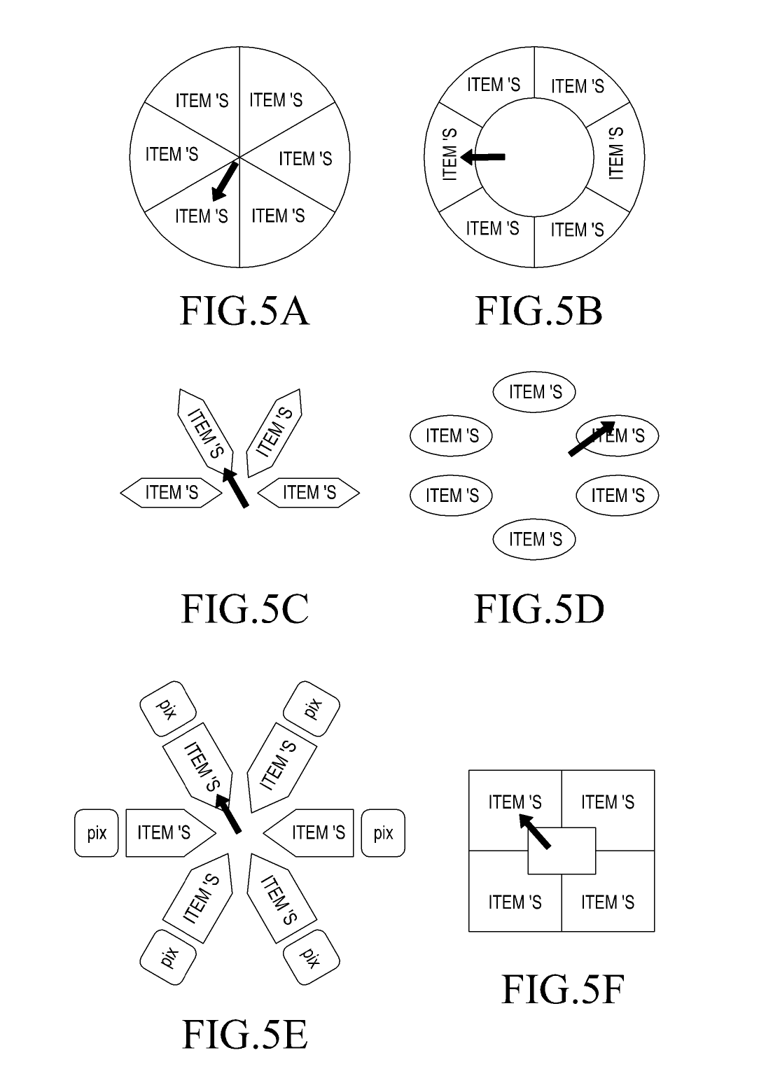

FIGS. 5A through 5F illustrate examples of menu forms according to an embodiment of the present invention. In one embodiment, as illustrated in FIG. 5A, the menu may be configured in a circular shape. The circular menu has different items as illustrated in the FIG. 5A. The items mentioned herein referred to the options available within the mobile device which may include a camera, wallpaper, delete, move, gallery, and the like. The user may select an option in the circular menu displayed by a touch or with a swipe without removing the touch. In a similar fashion, the menu options may be configured as illustrated in the FIGS. 5B, 5C, 5D, 5E and 5F, respectively. In FIG. 5E, “pix” represents a picture or icon of the ITEM's. For example, for camera ITEM, a picture or icon of the camera is displayed.

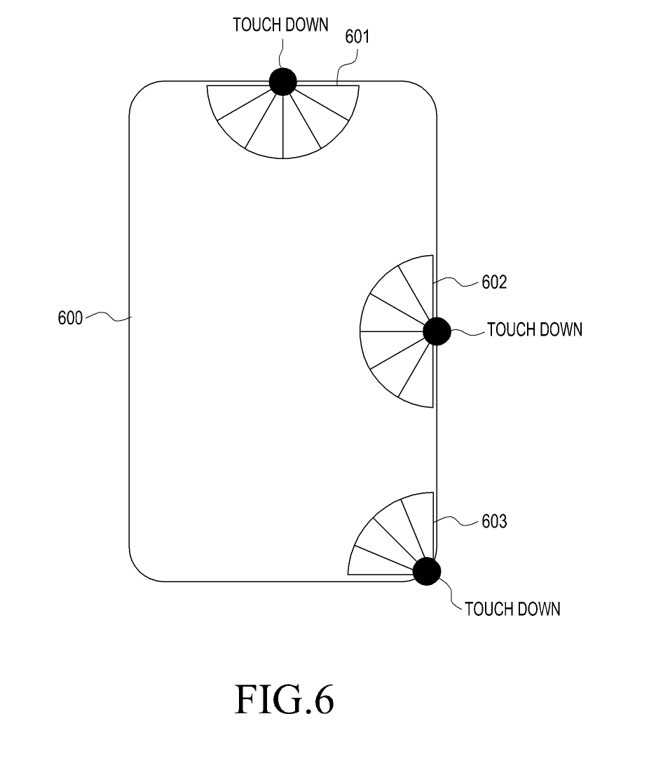

FIG. 6 illustrates examples of other menu forms according to an embodiment of the present invention. As illustrated in FIG. 6, when a touch is made in a border (or boundary) on a screen 600, menus may be displayed as indicated by reference numerals 601 through 603 according to touch down points.

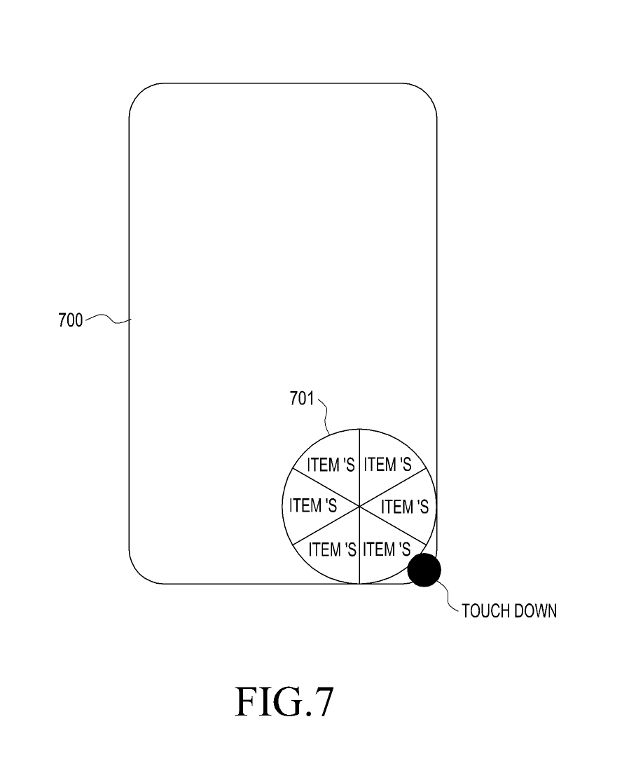

FIG. 7 illustrates an example of other menu forms according to an embodiment of the present invention. As illustrated in FIG. 7, when a touch is made at an edge on a screen 700, if more options than in the menu 603 shown in FIG. 6 are required, a circular menu may be displayed near a touch down point, such as menu 701.

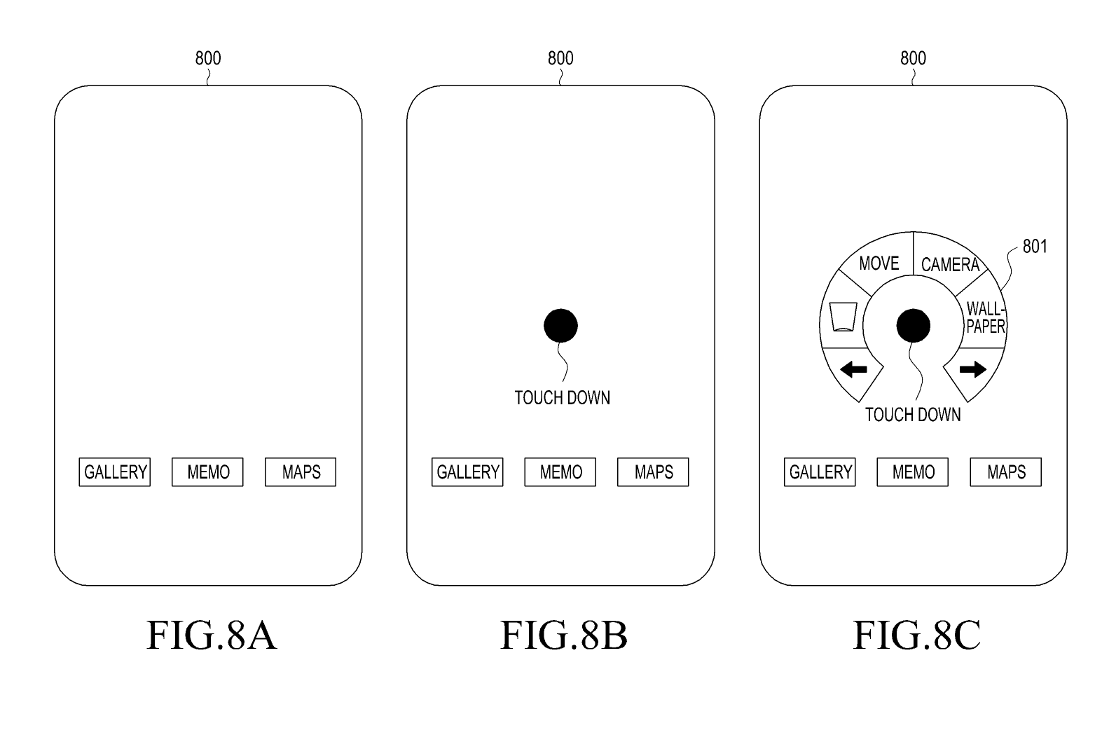

FIGS. 8A through 8C are examples of a menu display for touch and swipe navigation according to an embodiment of the present invention. Menu 801 shows an example menu on a display screen 800. In the state as illustrated in FIG. 8A, if a touch is made as illustrated in FIG. 8B, the menu 801 is displayed to correspond to a touch down point, as illustrated in FIG. 8C. The menu 801 consists of a camera, move, wallpaper options and left-right navigation buttons. These options may be customized by the user for display in the menu.

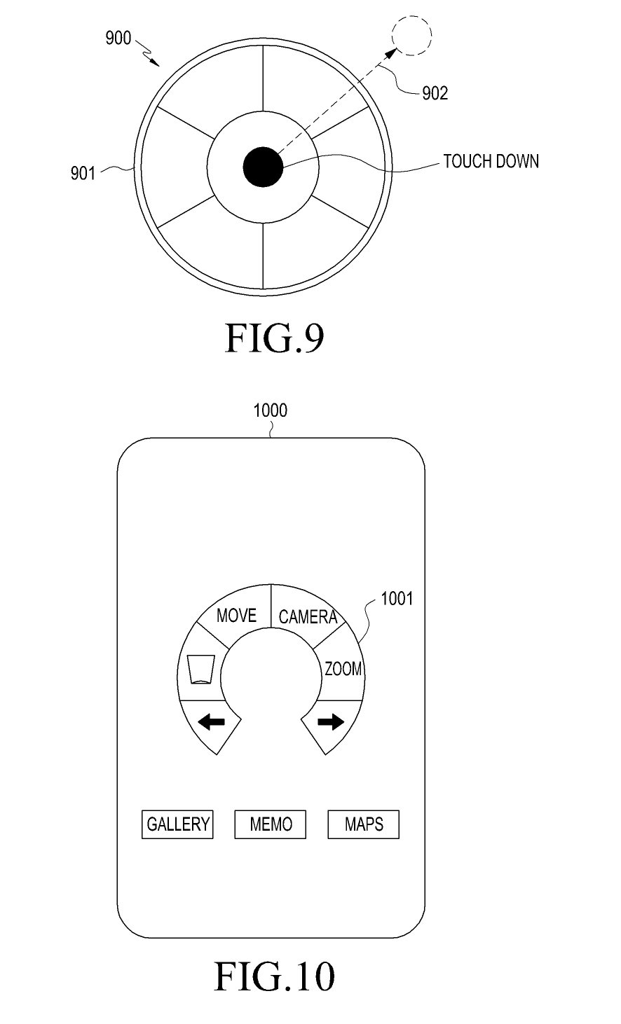

FIG. 9 illustrates a swipe out action according to an embodiment of the present invention. As shown in FIG. 9, a menu 900 consists of a menu boundary 901. In one embodiment, if the user swipes out at 902 of menu boundary 901 from the touch down point without removing the touch, the mobile device identifies this as a swipe out and displays the sub menu of the option in which the user swipes out. For example, if the user swipes out on a messaging option available in the displayed menu, then the mobile device displays the sub menu in the messaging option such as inbox, outbox, sent items, etc.

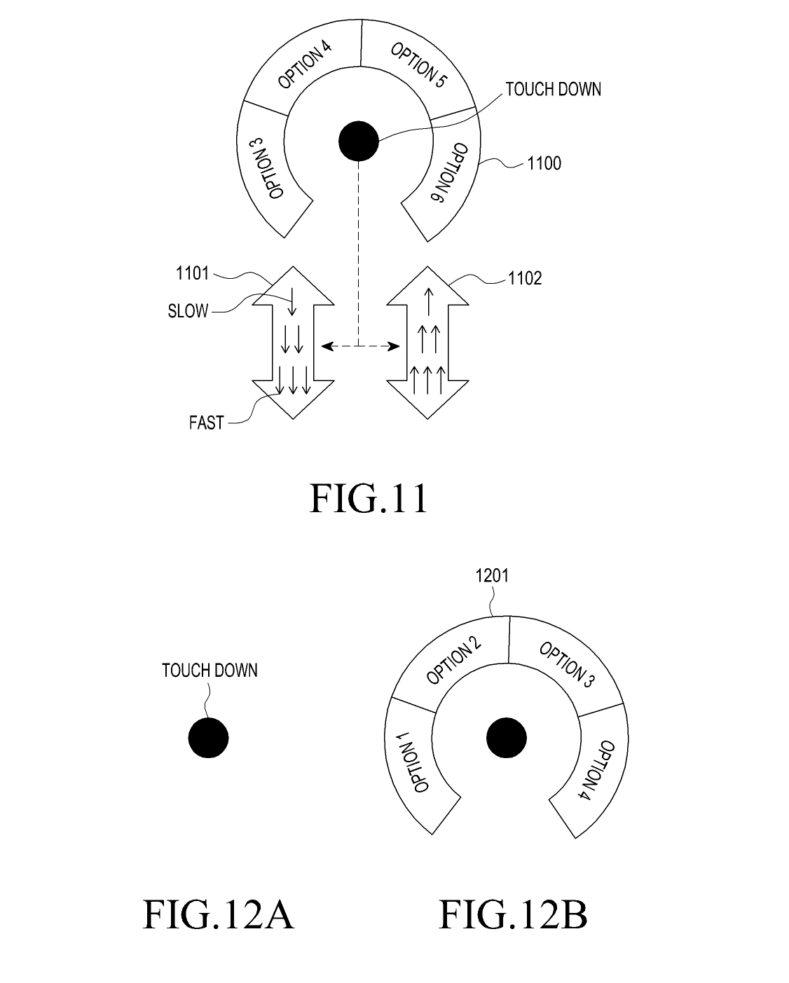

FIG. 10 illustrates a sub menu according to an embodiment of the present invention. The mobile device identifies that the user has performed a swipe out action in the displayed menu on a screen 1000. Then the mobile device displays the sub-menu of the option within the menu itself In one embodiment, the mobile device identifies that the user has performed a swipe out action over the image option, and then the mobile device displays the sub-menu zoom 1001 so that user may perform actions such as zoom-in, zoom-out and the like. The sub menu mentioned above will be displayed within the image option of the menu. The mobile device displays the sub-menu in a single touch performed by the user.

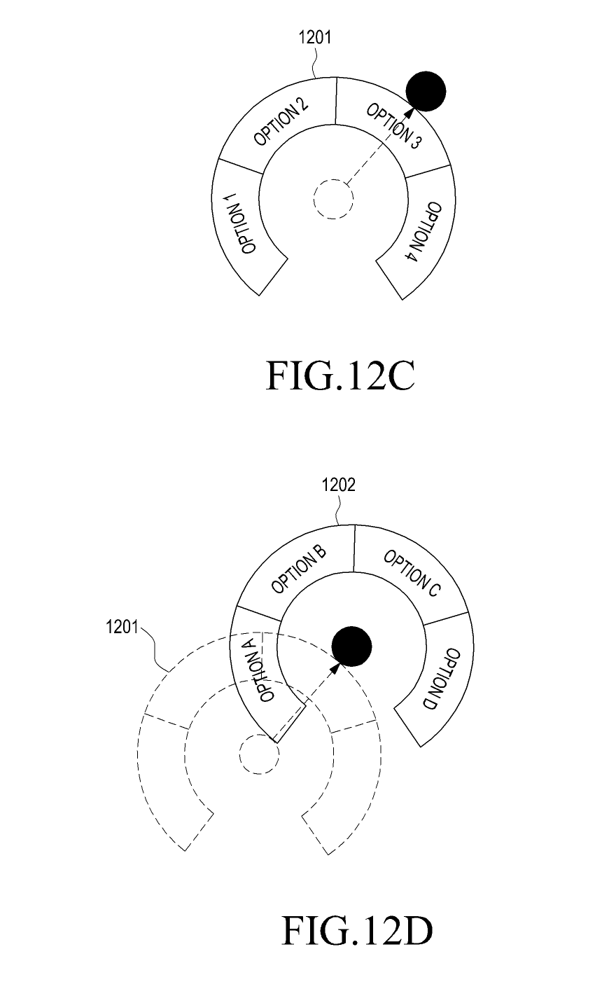

FIG. 11 illustrates a menu with scroll speed control options for menu options according to an embodiment of the present invention. Options of a menu 1100 shown in FIG. 11 may be scrolled using scroll buttons 1101 and 1102. In the example shown in FIG. 11, the scroll button 1101 is used to scroll the options in a clockwise direction and the scroll button 1102 is used to scroll the options in a counterclockwise direction. The user swipes from the touch down point to the scroll button 1101 or the scroll button 1102 to scroll the options in the clockwise direction or the counterclockwise direction. According to the swipe location with respect to the scroll buttons 1101 and 1102, the scroll speed is selected to be “SLOW” and “FAST” in FIG. 11. That is, in the example of FIG. 11, the scrolling speed is controlled in proportion to the distance of the swipe start and end points. In one embodiment, the swipe start is a touch down point at which the user starts the swipe, and the swipe end is the point at which the user ends the swipe with respect to the scroll buttons 1101 and 1102. Based on swipe start and end points, the mobile device determines the scrolling speed and controls the speed.

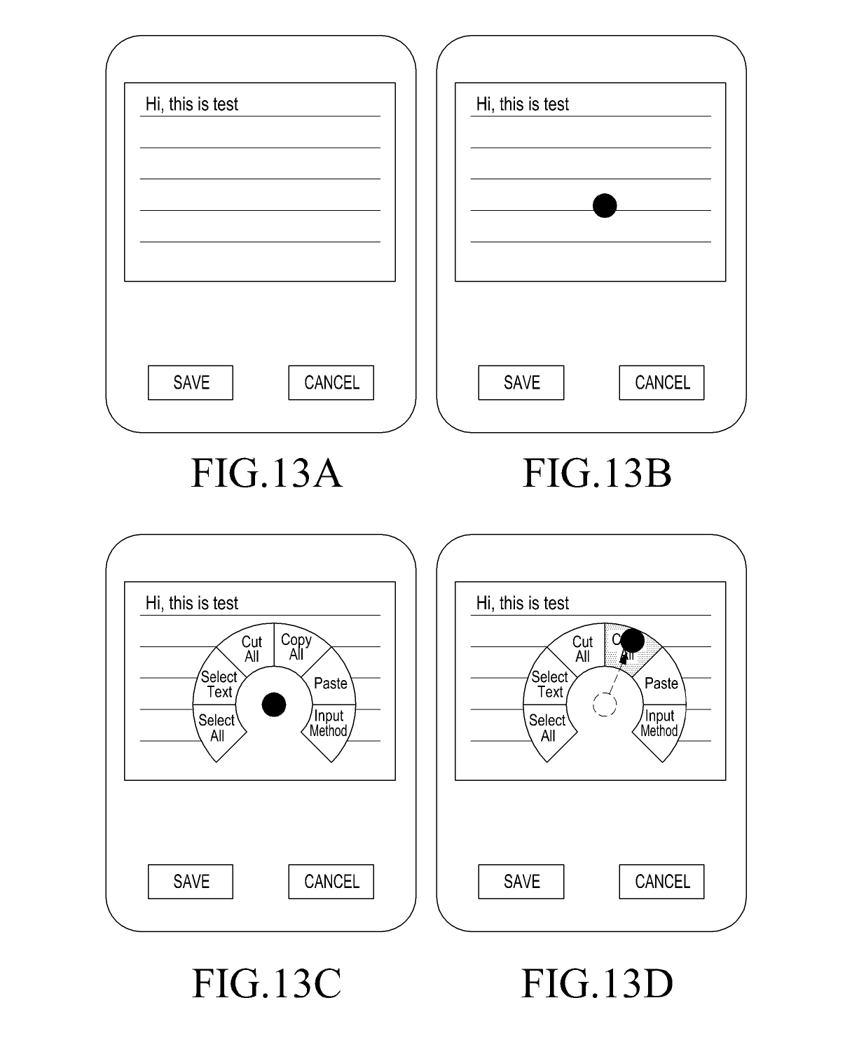

FIGS. 12A through 12D illustrate a menu and a sub menu options according to an embodiment of the present invention. If the user swipes out in a menu 1201 displayed as illustrated in FIG. 12B by a touch as illustrated in FIG. 12A, without removing the touch as illustrated in FIG. 12C, then a sub menu 1202 of option 3 selected by the swipe is displayed for option 3 as illustrated in FIG. 12D. The submenu 1202 is displayed in a single swipe of the option by the user and is displayed on the same screen. In one embodiment, the user selects the music option in the displayed menu and the mobile device displays the sub menu such as artists, tracks, playlist and the like. The sub-menu mentioned above is displayed by a single swipe by the user in the music option and displayed on the same screen of the mobile device.

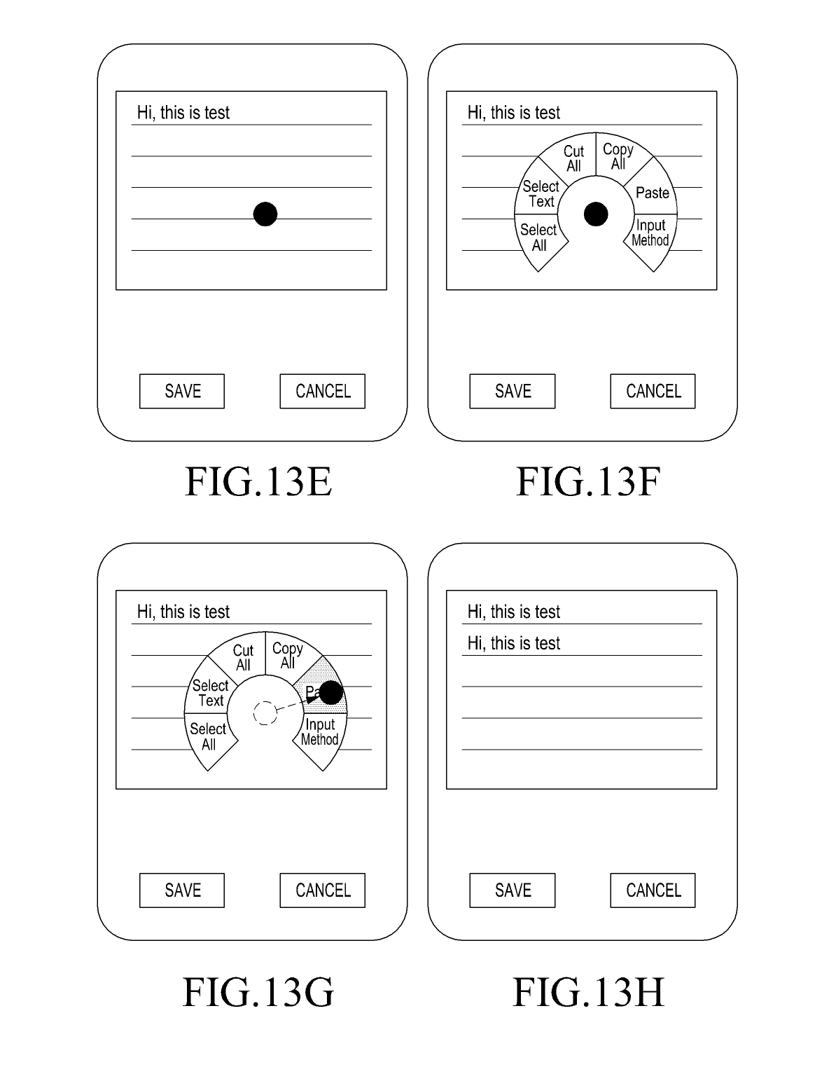

FIGS. 13A through 13H illustrate a message screen according to an embodiment of the present invention. In a state where the user generates a message as illustrated in FIG. 13A, if a touch is made as illustrated in FIG. 13B, then a menu including options is displayed as illustrated in FIG. 13C. Next, if the user swipes from a touch down point to a menu item “Copy All” as shown in FIG. 13D, the menu item “Copy All” is selected and a text generated at that time, “Hi, this is test” is copied and the menu disappears. Thereafter, if the user makes a touch as illustrated in FIG. 13E, the menu is displayed again as illustrated in FIG. 13F. If the user swipes from the touch down point to a menu item “Paste” as illustrated in FIG. 13G, then the menu item “Paste” is selected, such that the copied text is displayed as shown in FIG. 13H.

The embodiments disclosed herein may be performed by a standalone integrated circuit or an integrated circuit present within the device as described herein, where the integrated circuit is an electronic circuit manufactured by the patterned diffusion of trace elements into the surface of a thin substrate of semiconductor material. The integrated circuit further comprises at least one processor and one memory element. The integrated circuit may be a digital integrated circuit, an analog integrated circuit or a combination of analog and digital integrated circuits and made available in a suitable packaging means.

The embodiments disclosed herein can be implemented through at least one software program running on at least one hardware device and performing network management functions to control the elements. The controller shown in FIG. 1 includes blocks which can be at least one of a hardware device, or a combination of hardware device and software.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, those skilled in the art will recognize that the embodiments herein can be practiced with modification within the spirit and scope of the embodiments as described herein.

What is claimed:

1. A method for providing a user interface for touch and swipe navigation on a mobile device having a touch screen display, the method comprising:
identifying a touch action performed by a user on the touch screen display;
identifying a context related to the touch action;
displaying a menu based on the identified context; and
selecting a menu option corresponding to a direction of a swipe performed on the menu from among options of the menu, without removing the touch.

2. The method as in claim 1, further comprising:
checking for an inactivity period; and
closing the menu if the inactivity period has elapsed.

3. The method as in claim 1, wherein identifying the context comprises: determining an initial point of touch, determining a final point of touch, determining a direction of the touch action, and linking a choice made by the user.

4. The method as in claim 1, wherein the direction of the swipe comprises an angle and location of the swipe on the touch screen display.

5. The method as in claim 2, wherein closing the menu is performed by dimming the menu until the menu disappears.

6. The method as in claim 1, wherein the mobile device is at least one of a mobile phone, a smart phone, a tablet, and a laptop.

7. The method as in claim 1, further comprising displaying a next sub menu under a menu option selected by the swipe, when the swipe moves out of the area for a choice on the menu.

8. A mobile device for providing a user interface for touch and swipe navigation, the mobile device comprising:
a touch screen display; and
a controller for identifying a touch action performed by a user on the touch screen display, identifying a context related to said the touch action, displaying a menu based on the identified context, and selecting a menu option corresponding to a direction of a swipe performed on the menu from among options of the menu, without removing the touch.

9. The mobile device as in claim 8, wherein the controller checks for an inactivity period on the menu, and closes the menu if the inactivity period has elapsed.

10. The mobile device as in claim 8, wherein the controller identifies the context by determining an initial point of touch, determining a final point of touch, determining a direction of the touch action, and linking a choice made by the user.

11. The mobile device as in claim 8, wherein the direction of the swipe comprises an angle and location of the swipe on the touch screen display.

12. The mobile device as in claim 9, wherein the controller closes the menu by dimming the menu until the menu disappears.

13. The mobile device as in claim 8, wherein the mobile device is at least one of a mobile phone, a smart phone, a tablet and a laptop.

14. The mobile device as in claim 8, wherein the controller displays a next sub menu under a menu option selected by the swipe, when the swipe moves out of the area for a choice on the menu.
